(19) United States
(12) Patent Application Publication
(10) Pub. No.: US 2003/0134595 A1
(43) Pub. Date: Jul. 17, 2003

(54) Optimization of eirp via efficient redundancy pooling concepts

(76) Inventors: Nicholas F. DiCamillo, Torrance, CA (US); Daniel R. Franzen, Hermosa Beach, CA (US); Daniel R. Lane, Santa Monica, CA (US)

Correspondence Address: PATENT COUNSEL, TRW INC., S & E LAW DEPT., ONE SPACE PARK, BLDG. E2/6051, REDONDO BEACH, CA, 90278, US

(21) Appl. No.: 10/044,285

(22) Filed: Jan. 11, 2002

(51) Int. Cl. H04B 7/185

(52) U.S. Cl. 455/13.4; 455/12.1; 455/427

(57) ABSTRACT

A communications satellite has multiple HPA redundancy pools. All downlink feed signals driven by HPAs in any one of the HPA redundancy pools are placed on a first number of antenna apertures which is less than the total number of available antenna apertures and, in the event that a HPA driving a downlink feed signal fails, only one of the other HPAs co-located in that same HPA redundancy pool may drive that downlink feed signal. Each one of the HPA redundancy pools provides downlink feed signals to the same number, but a different unique combination, of antenna apertures and is located so that the waveguide run length between it and the furthest antenna aperture in the unique combination of antenna apertures containing downlink feed signals provided by it is minimized.

### BACKGROUND OF THE INVENTION

1. Field of the Invention

The present invention relates to communication satellites. More particularly, the present invention relates to the use of redundancy pools for driving downlink signal feeds in a communications satellite.

2. Discussion of the Related Art

FIG. 1 is an illustration of two satellites in a conventional satellite communications network. Satellites 620 and 640 provide communications to parts of a large region 610 of Earth, such as North America, including several ground stations 630, using a few large coverage areas in a uniform distribution method. With such satellites, if traffic demand increases in one location of region 610, the few large coverage areas of satellites 620 and 640 cannot be reconfigured in orbit to handle the additional load from the increased traffic at that location.

It is possible to utilize multiple feeds to form multiple spot beams which each target a specific location of region 610. Conventionally, only a relatively small number of feeds could be placed within a single antenna due to the large feed horn size. However, with the spot beam antenna technology described in U.S. Pat. Nos. 6,211,835, 6,215,452 and 6,236,375, assigned to the assignee of this patent application and hereby incorporated by reference in their entirety, it is possible to have systems with a large number of spot beams, 32 or more for example.

FIG. 2 is an example illustration of spot beams positioned over predefined Earth locations utilizing the previously mentioned antenna system. Satellite 710 positions its spot beams 740 to cover South America and the east coast of the United States from its location at 47 degrees west longitude.

Once the feeds are set within a satellite using a uniform distribution method, they may not be changed individually to target another geographical location. However, unlike a uniform distribution method, the spot beams used in a non-uniform coverage method may be directed towards those areas where demand is highest. The positioning of the spot beams can be determined by the physical alignment of the feeds in the antenna of the satellite and the longitude at which the satellite is positioned in geo-synchronous orbit such as detailed in U.S. Pat. Nos. 6,211,835; 6,215,452; and 6,236,375.

Spot beam broadband systems frequently divide the system's capacity into beam groups. In a typical system, each group consists of a number of coverage regions on the ground and the related satellite resources allocated to serving these regions. They can have switches to change which spot beam will be transmitted or to switch signals between different paths, and individual examples of switching downlink beams are common. More than one payload channel may be directed at any given location within the range of the satellites. Systems historically have pre-defined how spectrum was to be allocated among the coverage areas and hard-wired power-dividers, power-divide modules or other modules were used to allocate bandwidth. The problem with this approach is that demand for the system is highly uncertain, and it is likely that some cells will have over-allocated resources while others will have under-allocated resources. There is a need for a flexible approach to on-orbit, reallocate satellite downlink channel bandwidth among cells in a group.

In a communications satellite having multiple antenna apertures with downlink beam flexibility, high power amplified (HPA) downlink feed signals must be routed to the appropriate downlink beam transmitted from a downlink antenna aperture. Conventionally, the downlink feed signal driven by a given HPA is always routed to the same downlink antenna aperture. But with on-board downlink flexibility, the downlink feed signal driven by a HPA may need to be routed to a different downlink beam transmitted from a different aperture. Since the HPA now must be routed to multiple downlink antenna apertures, the waveguide lengths between the HPA and the various downlink antenna apertures typically increase.

It is a problem to optimize the downlink EIRP (effective isotropic radiated power) performance of the payload in a communications satellite having downlink beam flexibility. Conventionally, all of the downlink spot beams are on one downlink antenna aperture and are driven by one or more HPA redundancy pools. The HPA redundancy pools are located as close as possible to that downlink antenna aperture. Although this solution reduces waveguide lengths, since all downlink feed signals are on one aperture, the antenna gain performance is severely degraded, given adjacent cells of a coverage region, or cells in close proximity to each other. As a result, this solution will not result in optimal downlink EIRP and high antenna gain.

### BRIEF SUMMARY OF THE INVENTION

The example embodiments of the present invention provide a communications satellite having multiple HPA redundancy pools. All downlink feeds which are driven by one of the HPA redundancy pools are placed on a first number of antenna apertures which is less than the total number of available antenna apertures and all of the HPAs servicing said downlink feeds are co-located only in said one HPA redundancy pool. Each one of the multiple HPA redundancy pools services the same number, but a different combination, of antenna apertures less than the total number of available antenna apertures and is located so that the waveguide run length between it and the furthest antenna aperture containing downlink feeds serviced by it is minimized.

Other embodiments, objects, advantages and salient features of the invention will become apparent from the following detailed description taken in conjunction with the annexed drawings, which disclose preferred embodiments of the present invention.

### BRIEF DESCRIPTION OF THE DRAWINGS

The foregoing and a better understanding of the present invention will become apparent from the following detailed description of example embodiments and the claims when read in connection with the accompanying drawings, all forming a part of the disclosure of this invention. While the foregoing and following written and illustrated disclosure focuses on disclosing example embodiments of the invention, it should be clearly understood that the same is by way of illustration and example only and the invention is not limited thereto.

The following represents brief descriptions of the drawings in which like reference numerals represent like elements and wherein:

FIG. 1 illustrates a satellite communications network;

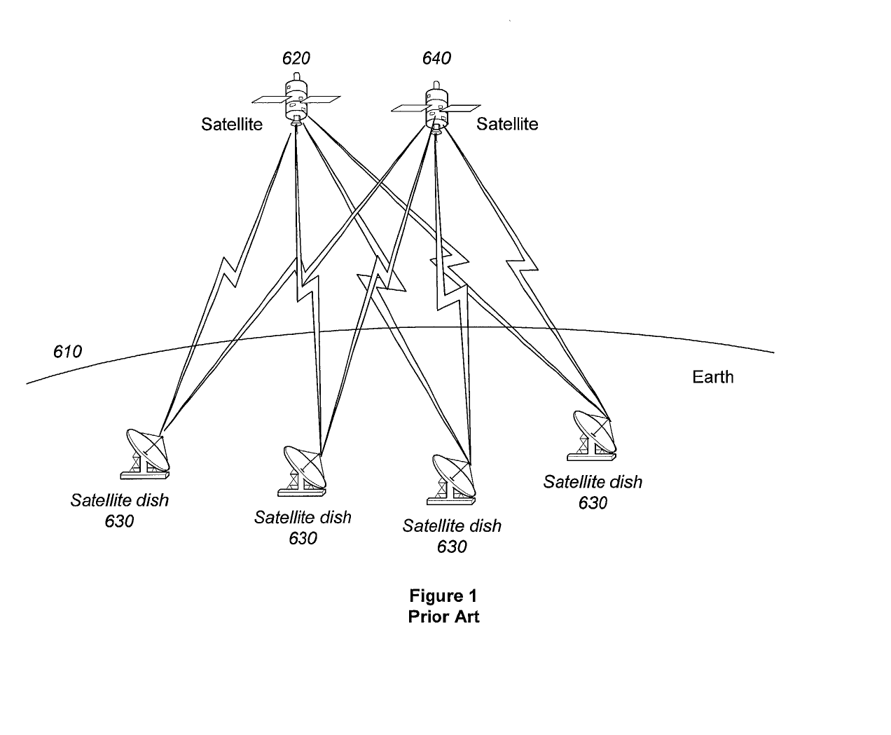

FIG. 2 illustrates spot beams positioned over Earth;

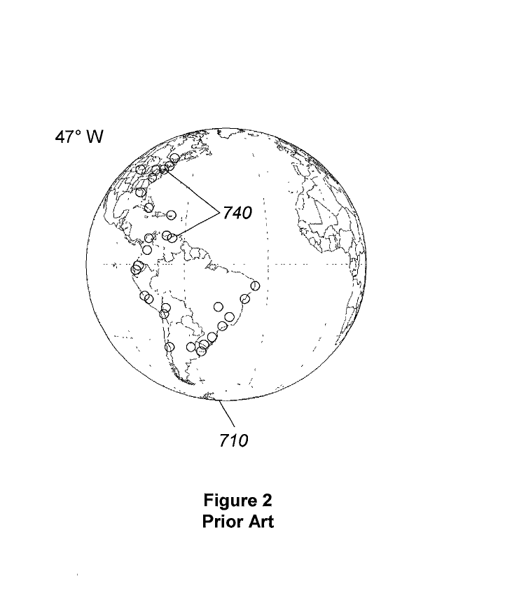

FIG. 3 is a block diagram illustrating a satellite payload architecture in an example embodiment of the present invention;

FIG. 4 illustrates an example of redundancy pooling used in the example embodiment of the present invention;

FIG. 5 illustrates a downlink switching mechanism in the example embodiment of the present invention; and

FIG. 6 illustrates the concepts involved with organizing multiple redundancy pools according to the example embodiment of the invention.

### DETAILED DESCRIPTION OF THE INVENTION

In the following detailed description, like reference numerals and characters may be used to designate identical, corresponding, or similar components in differing drawing figures. Furthermore, in the detailed description to follow, example values may be given, although the present invention is not limited thereto. Well-known power connections and other well-known elements have not been shown within the drawing figures for simplicity of illustration and discussion and so as not to obscure the invention.

A communications satellite according to the example embodiment of the invention has multiple HPA redundancy pools. All downlink feed signals driven by HPAs in any one of the HPA redundancy pools are placed on a first number of antenna apertures which is less than the total number of available antenna apertures and, in the event that a HPA driving a downlink feed signal fails, only one of the other HPAs co-located in that same HPA redundancy pool may drive that downlink feed signal. Each one of the HPA redundancy pools provides downlink feed signals to the same number, but a different unique combination, of antenna apertures and is located so that the waveguide run length between it and the furthest antenna aperture in the unique combination of antenna apertures containing downlink feed signals provided by it is minimized.

Before describing the example embodiments of the present invention, a brief overview of an exemplary satellite payload architecture will be provided. The exemplary satellite payload architecture to be described is capable of receiving high frequency uplink beams at a plurality of receive antennas, converting the higher frequency to a lower frequency for switching and filtering of channels, converting the lower frequency signals to a higher frequency, and distributing the high power signals to one of the plurality of transmit antennas. As one example, the satellite may be a communications satellite for use with broadband communications such as for the Internet. The satellite may include numerous types of antenna structures. For example, the antennas may be an offset Cassegrain or Gregorian antenna having a subreflector, a main reflector and a separate feed array. Other types of satellites and antenna structures are also within the scope of the present invention.

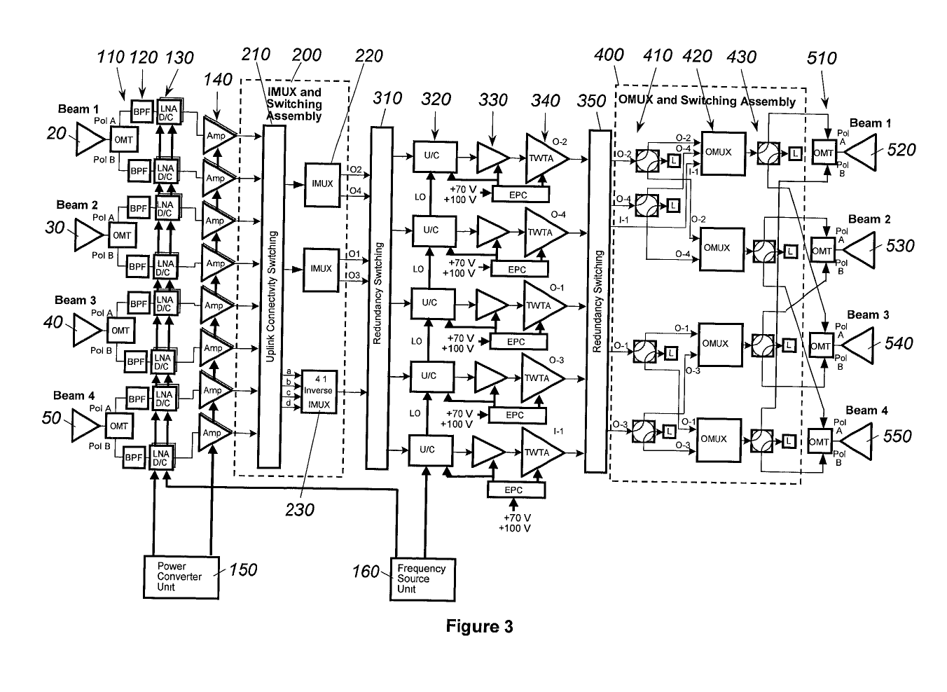

FIG. 3 is a block diagram illustrating exemplary electronics in a payload for one beam group of a multi-beam satellite. Other electronics may also be used with the example embodiment of the invention. The satellite payload may include similar electronics for each of the other beam groups. As one example, the satellite may include antenna structures for receiving and transmitting numerous beam groups, for example eight beam groups.

FIG. 3 shows a first dual-polarization antenna 20, a second dual-polarization antenna 30, a third dual-polarization antenna 40 and a fourth dual-polarization antenna 50 each to receive uplink beams from Earth in a well-known manner. Upon receipt of the uplink signals (such as broadband communication signals) at the antennas, the received signals pass through four ortho-mode transducers (OMT) 110 to eight band pass filters (BPF) 120. The filtered signals may pass to eight low noise amplifier downconverters (LNA D/C) 130 that convert the received and filtered signals from a higher frequency (such as approximately 30 GHz in the Ka-band) to a lower frequency (such as approximately 4 or 5 GHz in the C-band).

The lower frequency signals may then be amplified by eight C-band utility amplifiers 140 and proceed to an Input Multiplexer (IMUX) and switching assembly 200. The IMUX and switching assembly 200 may include an uplink connectivity switching network 210, which may be a power dividing switching network. Signals output from the uplink connectivity switching network 210 may be input to either one of the two outbound input multiplexers (IMUX) 220 or to the 4:1 inverse IMUX 230. The IMUXes 220 output signals along forward channels O1, O2, O3 and O4 to a C-band redundant switching network 310. The 4:1 inverse IMUX 230 outputs signals along return channel 11 to the C-band redundancy switching network 310.

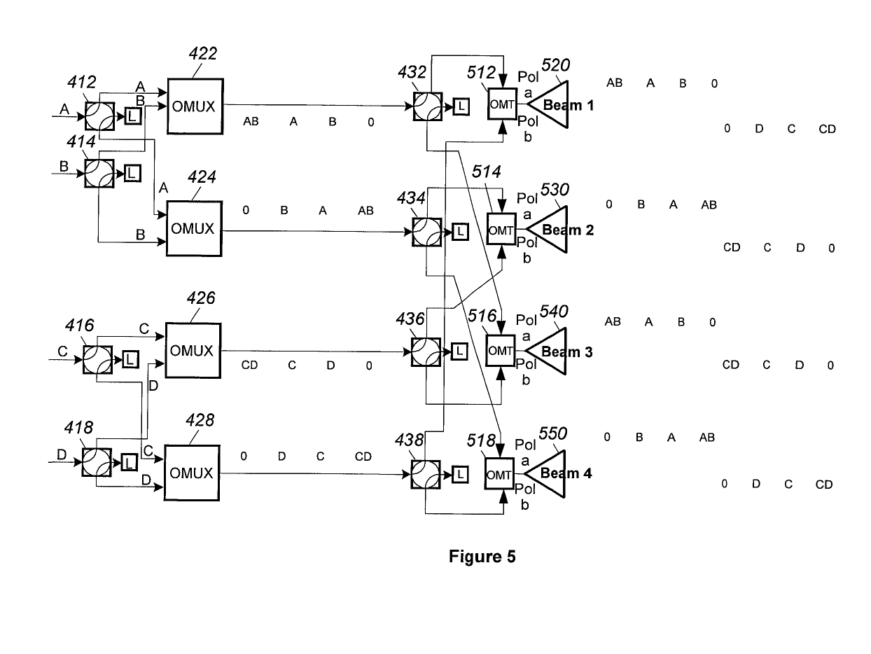

The C-band redundancy switching network 310 outputs signals to five up-converters (U/C) 320. The U/Cs 320 convert the lower frequency signals to higher K-band frequency signals (such as approximately 20 GHz) that will be used for transmission back to the Earth. The higher frequency K-band signals may then pass through five K-band linearized channel amplifiers 330 and five high power amplifiers (HPAs), preferably consisting of Traveling Wave Tube Amplifiers (TWTAs) 340. The five TWTAs 340 are high power amplifiers that supply the transmit RF power to achieve the downlink transmission. The five TWTAs 340 output four high power outbound signals O-1, O-2, O-3, O-4 to the users and one inbound signal I-1 to the gateway. The K-band redundancy switching network 350 provides the signals I-1, O-1, O-2, O-3 and O-4 to an Output Multiplexer (OMUX) and switching assembly 400 that will be described below with respect to FIG. 5.

The OMUX and switching assembly 400 may include mechanical switches 410 that couple the signals I-1, O-1, O-2, O-3 and O-4 to output multiplexers (OMUX) 420. The signals pass through the OMUXes 420 and are appropriately distributed to mechanical switches 430. The switches 430 distribute the signals to one of the downlink OMTs 510 and the corresponding downlink antenna such as a first dual-polarization downlink antenna 520, a second dual-polarization downlink antenna 530, a third dual-polarization downlink antenna 540 and a fourth dual-polarization downlink antenna 550.

A power converter unit 150 may also be provided to supply DC power to the LNA D/Cs 130 and the C-band utility amplifiers 140. Additionally, one centralized frequency source unit 160 supplies a local oscillation (LO) signal to the LNA D/Cs 130 and to the U/Cs 320. The power converter unit 150 and centralized frequency source unit 160 are shared across all beam groups of the satellite.

The IMUX and switching assembly 200 and the OMUX and switching assembly 400 operate to appropriately switch and filter uplinked signals from any one of the uplink antennas 20, 30, 40 and 50 to any one of the downlink antenna apertures 520, 530, 540 and 550. While FIG. 3 shows one embodiment for the IMUX and switching assemblies 200 and one embodiment for the OMUX and switching assembly 400, other embodiments and configurations may also be combined with the example embodiment of the present invention. The IMUX and switching assembly 200 may operate at lower frequency (such as 4 GHz) than the OMUX and switching assembly 400. As will be discussed below, the TWTAs 340 are optimally configured into multiple redundancy pools in order to minimize insertion losses between them and the downlink antenna apertures 520, 530, 540 and 550.

Redundancy pools allow a group of hardware to share access to spare units. The redundancy is provided at the hardware level, rather than the functional level. For example, TWTAs of the same power level may be pooled together with spare TWTAs of the same power level. Different degrees of sparing may be utilized and are generally described as having M-for-N-sparing, where M is the total number of available hardware groupings, N is the total number of initially active hardware groupings and M-N is the number of spare active hardware groupings.

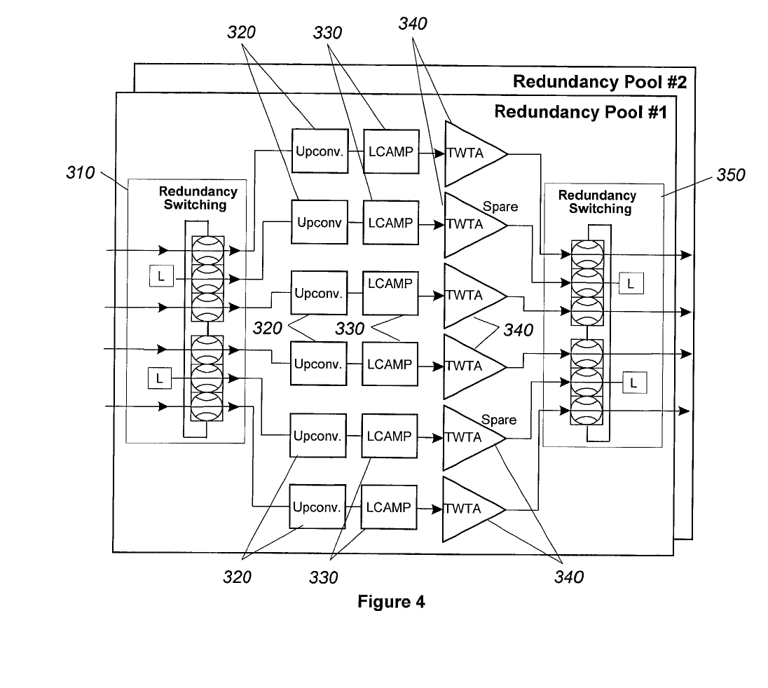

FIG. 4 illustrates an example of redundancy pooling used in the example embodiment of the invention. The example embodiment is not limited to the example of redundancy pooling shown in FIG. 4 and other examples of redundancy pooling may be used instead.

The example of redundancy pooling shown in FIG. 4 uses 6-for-4 sparing of entire strings. Although redundancy pools may provide sparing for single hardware units, the sparing in the example shown in FIG. 4 is done for entire strings. In addition to four active strings (each comprising an up-converter (U/C) 320, a K-band linearized channel amplifier 330, and a TWTA 340), there are two spare strings (each also comprising an up-converter (U/C) 320′, a K-band linearized channel amplifier 330′, and a TWTA 340′). Likewise, the C-band redundancy switching network 310 includes four switches for incoming signals provided to four respective active strings as well as two switches connected to respective loads and the two spare strings. The K-band redundancy switching network 350 includes four switches for signals output from the four active strings as well as two switches connected to the spare strings and to respective loads.

Preferably, many redundancy pools are utilized in the example embodiments. In addition, auxiliary connectivity between redundancy pools (not shown) provides functionality in a worst-case failure. Although the example 6-for-4 redundancy pools may be used for the outbound signals O-1, O-2, O-3 and O-4 in a single respective beam group, it is preferred that each pool contains strings from more than one beam group. For example, one redundancy pool may contain strings for the O-1 outbound signals in each of four different beam groups, while another redundancy pool contains strings for the O-2 outbound signals, and so on. Alternatively, one redundancy pool may contain strings for the O-1 outbound signal in a first beam group, the O-2 outbound signal in a second beam group, the O-3 outbound signal in a third beam group, and the O-4 outbound signal in a fourth beam group while other redundancy pools are staggered among the beam groups so that a spare is provided for each string. In any event, each pool is configured to provide stand-alone sparing of the strings in its pool.

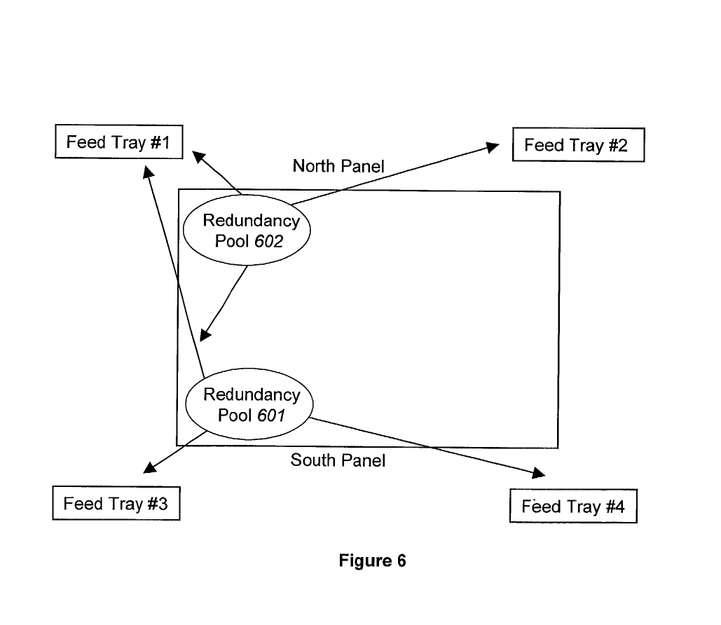

In a multi-beam communications payload, there is a desire to flexibly and efficiently change the capacity delivered to downlink beams in a given beam group on-orbit, by re-allocating high power amplified (HPA) channels between downlink beams in a beam group. As one example, there may be a need to route between 1 and 4 HPA channels among 4 dual-polarization downlink beams, either by routing all 4 HPA channels to any one of the 4 downlink beams, or by routing one or more HPA strings to several of the 4 downlink beams. Preferably, the satellite uses the downlink switching described below with respect to FIG. 5 and the redundancy pooling described below with respect to FIG. 6. They may enable the flexible allocation of capacity (4 channels) among 4 dual-polarization downlink beams, while maintaining low post-HPA insertion loss, and maximizing EIRP performance. While this embodiment will be described with respect to four channels and four downlink beams, other numbers of channels and downlink beams are also within the scope of the present invention.

Embodiments of the present invention may deliver capacity flexibility by utilizing the specific combination of post-HPA switches, output multiplexers (OMUXs), and post-multiplexer switches described below or some other combination. The combination described below may deliver capacity re-allocation and surge capability among 4 HPA channels and 4 downlink beams. Any one of 4 HPA channels may be routed to any of the 4 downlink beams with minimum blockages of which HPA strings are routed to a particular beam. This may involve routing each of the 4 HPA outputs to one of the four 1:2 post-HPA switches (C-Switches). The outputs of the post-HPA switches may be coupled to four 2:1 output multiplexers that combine 2 channels into one output channel. The output of each multiplexer may be coupled to a 1:2 C-Switch that couples the multiplexed signal to one of two downlink beams. Since each HPA is routed through a 1:2 switch and then to a 1:2 switch, each HPA may be routed to one of 4 downlink beams.

Additionally, a 1:3 switch (R-switch) may also be used rather than the 1:2 switch (C-switch). The third output of the 1:3 switch may be used as a test port and may be routed to a test panel or to a test set. This may allow access to test the high power signal without breaking the repeater to antenna interface.

Embodiments of the present invention are not limited to 4 HPA channels and 4 downlink beams. Many different combinations of channels and beams are also within the scope of the present invention. For example, 8 HPA channels and 4 downlink beams may be used. In this example, eight 1:2 post-HPA switches, four 4:1 OMUXs, and four 1:2 switches may be configured to enable capacity flexibility among 8 HPA strings and 4 dual-polarization downlink beams. As another example, when 4 HPA channels and 8 downlink beams are used, then four 1:4 switches, eight 2:1 OMUXs, and eight 1:2 switches may be configured to enable capacity flexibility among 4 HPA chains and 8 dual-polarization downlink beams.

FIG. 5 shows the OMUX and switching assembly 400 (shown in FIG. 3) according to one example embodiment of the present invention. In this example embodiment, the I-1 channel has been omitted for clarity. Other embodiments and configurations are also within the scope of the present invention. As shown in FIG. 5, the OMUX and switching assembly 400 may receive a first HPA signal A, a second HPA signal B, a third HPA signal C and a fourth HPA signal D. Each of the signals A-D may correspond to the signals O-2, O4, O-1 and O-3 output from the TWTAs 340 (FIG. 3) or output from the redundancy switching network 350. The OMUX and switching assembly 400 distributes the respective signals to the desired output antenna preferably with a minimum number of intermediate hardware in order to minimize the insertion loss to be the lowest possible.

The OMUX and switching assembly 400 may include a plurality of mechanical switches 412, 414, 416 and 418, a plurality of OMUXes 422, 424, 426 and 428 and a plurality of switches 432, 434, 436 and 438. A state of each of these components may be appropriately controlled by a control unit to ensure proper distribution of the signals. Each of the switches may be a C-type of mechanical switch, for example. Other types of switches are also within the scope of the present invention. The OMUXes may contain filter mechanisms. Because each of the switches and OMUXes have insertion loss, it is desirable to minimize the number of those elements since insertion loss leads to power reduction in the transmitted downlink beams.

As shown in FIG. 5, the signal A may pass through the switch 412 to either the OMUX 422 or the OMUX 424 based on a state of the switch 412. Similarly, the signal B may pass through the switch 414 to either the OMUX 422 or the OMUX 424 based on a state of the switch 414. The signal C may pass through the switch 416 to either the OMUX 426 or the OMUX 428 based on a state of the switch 416. Likewise, the signal D may pass through the switch 418 to either the OMUX 426 or the OMUX 428 based on a state of the switch 418.

The OMUX 422 in combination with the switches 412 and 414 allow four different signals or combinations of signals to be output from the OMUX 422. As shown, these possibilities include the following: AB, A, B and 0, where 0 represents no signal. Likewise, the OMUX 424 in combination with the switches 412 and 414 allow four different signals or combinations of signals to be output from the OMUX 424. As shown, these possibilities include the following: O, B, A, and AB. Still further, the OMUX 426 in combination with the switches 416 and 418 allow four different signals or combinations of signals to be output from the OMUX 426. As shown, these possibilities include the following: CD, C, D and O. Finally, the OMUX 428 in combination with the switches 416 and 418 may output four different signals or combinations of signals from the OMUX 428. As shown, these possibilities include the following: O, D, C and CD.

The signals output from the OMUX 422 may pass through the switch 432 and be distributed to either the OMT 512 or the OMT 516 based on the state of the switch 432. The signals output from the OMUX 424 may pass through the switch 434 and be distributed to either the OMT 514 or the OMT 518 based on the state of the switch 434. The signals output from the OMUX 426 may pass through the switch 436 and be distributed to either the OMT 514 or the OMT 516 based on the state of the switch 436. Finally, the signals output from the OMUX 428 may pass through the switch 438 and be distributed to either the OMT 512 or the OMT 518 based on the state of the switch 438.

The OMT 512 outputs the received signals to the antenna 520 that transmits the downlink beam 1, the OMT 514 outputs the received signals to the antenna 530 that transmits the downlink beam 2, the OMT 516 outputs the received signals to the antenna 540 that transmits the downlink beam 3 and the OMT 518 outputs received signals to the antenna 550 that transmits the downlink beam 4. As may be seen to the right of each of the antennas 520, 530, 540 and 550, the HPA signals A, B, C and D may be distributed to any one of the antennas 520, 530, 540 and 550 alone or in combination.

A redundancy pooling switch may be substituted for any one of the switches 432, 434, 436 or 438. The redundancy pooling switch may be an R switch having three outputs. It may receive the high power signal from one of the OMUXes 422, 424, 426 or 428 and may distribute the received signal to any one of three outputs. That is, if the redundancy pooling switch is substituted for the switch 438 in FIG. 5, then the signal output of the switch may pass to the OMT 512, the OMT 518 or to an access port based on a state of the switch. The output access port may be outside of the spacecraft so as to allow appropriate power testing outside of the spacecraft.

For the communications satellite having flexible downlink beams according to the example embodiment of the invention, each HPA string may be switched to provide signals to different downlink beams on all of the available downlink antenna apertures. However, as explained above, this means that the maximum waveguide length for an HPA is much longer. Therefore, all of the downlink signal feeds which are driven by a common HPA are provided to less than all of the downlink antenna apertures. Also, the HPA string is co-located in a HPA redundancy pool with other HPA strings driving the downlink signal feeds on the same combination of apertures.

FIG. 6 shows these concepts applied to an example communications satellite having four equidistant downlink antenna apertures. Assuming that an HPA can be switched to any one of four different downlink beams, the four downlink beams are placed on only three (or two) of the downlink antenna apertures. For example, all of the HPA strings in redundancy pool 601 only are switched to the feed trays of downlink antenna apertures 1, 3 and 4. All other HPA strings which are switched between the feed trays of downlink antenna apertures 1, 3 and 4 are co-located in redundancy pool 601. Similarly, a second redundancy pool 602 consists of the HPA strings driving downlink feed signals to the feed trays of downlink antenna apertures 1, 2 and 3. Although not shown in FIG. 6, a third redundancy pool consists of the HPA strings driving downlink feed signals to the feed trays of downlink antenna apertures 1, 2 and 4 and a fourth redundancy pool consists of the HPA strings driving downlink feed signals to the feed trays of downlink antenna apertures 2, 3 and 4. If all four downlink antenna apertures are utilized to provide optimal coverage with downlink spot beams driven by amplifiers from multiple centralized HPA redundancy pools organized as described herein, they will receive the maximum power and high antenna gain, resulting in optimal payload EIRP, and minimal required payload DC power consumption.

Any reference in the above description to “one embodiment”, “an embodiment”, “example embodiment”, etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the knowledge of one skilled in the art to effect such feature, structure, or characteristic in connection with other ones of the embodiments.

Although the present invention has been described with reference to a number of illustrative embodiments thereof, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art.

What is claimed is:

1. A communications satellite comprising:
a plurality of available downlink antenna apertures, each downlink antenna aperture transmitting a plurality of downlink feed signals;
a plurality of switching devices to selectively switch a plurality of input signals and provide a plurality of switched signals; and
a plurality of high power amplifiers (HPAs), each one of said plurality of switched signals being received and driven by one of said plurality of HPAs into a corresponding one of said plurality of switching devices and downlink feed signals, wherein said plurality of HPAs are organized into multiple HPA redundancy pools, each one of the multiple HPA redundancy pools providing downlink feed signals to a respectively unique combination of said plurality of downlink antenna apertures.

2. The satellite of claim 1, wherein each one of said multiple HPA redundancy pools provides downlink feed signals to the same number of downlink antenna apertures as the other ones of said multiple HPA redundancy pools.

3. The satellite of claim 2, wherein said same number of downlink antenna apertures is between 2 and N-1, where N is the number of available downlink antenna apertures, greater than or equal to 3.

4. The satellite of claim 2, wherein each one of said HPA redundancy pools is located so that the waveguide run length between it and the furthest downlink antenna aperture of its unique combination of downlink antenna apertures is minimized.

5. The satellite of claim 1, further comprising a plurality of uplink antenna apertures to receive a plurality of uplink beams.

6. The satellite of claim 5, wherein each of said plurality of uplink beams from corresponding ones of said uplink antenna apertures are provided as said input signals to said plurality of switching devices.

7. The satellite of claim 1, wherein said signals relate to broadband communications.

8. The satellite of claim 1, further comprising a control unit to control operation of at least said plurality of switching devices such that each input signal is routed to a desired downlink antenna aperture.

9. The satellite of claim 1, wherein the event that one of the HPAs in a HPA redundancy pool fails, one of the other HPAs in said HPA redundancy pool drives the downlink feed signal of said one of the HPAs.
